(19) United States
(12) Patent Application Publication
(10) Pub. No.: US 2012/0235889 A1
(43) Pub. Date: Sep. 20, 2012

(54) AUTOMOBILE-MESSAGING SYSTEM HAVING GOVERNMENT OVERRIDE CAPABILITY

(76) Inventors: EDWARD RAPPAPORT, Pembroke Pines, FL (US); Nancy Rappaport, Pembroke Pines, FL (US)

(21) Appl. No.: 13/047,820

(22) Filed: Mar. 15, 2011

(51) Int. Cl. G09G 3/36; G08B 5/00

(52) U.S. Cl. 345/87; 340/815.4

(57) ABSTRACT

The automobile-messaging system having government override is a messaging system that sits atop a vehicle and of which delivers highly visible messages in both a forward and rearward direction. A front display and rearward display are contained with a triangularly-shaped housing that includes translucent sides that enable sunlight to enter in order to produce electricity with solar cells located on an interior base of the housing. A remote can communicate with either the front or rear display to enable the respective motorist to input a desired message. A government override feature enables the government to commandeer use of the display by emitting a wireless signal that overrides any use of the system, and will display the desired government message. The messaging system is secured atop the vehicle by adhesives, magnets, clips, or clamps. The messaging system is powered via cigarette lighter electric cord, rechargeable batteries, and/or a plurality of solar cells.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

The present invention relates to the field of vehicular messaging systems, more specifically, a messaging system that alerts motorists and pedestrians of a message display atop a vehicle.

A need exists for a motorist to communicate with other motorists and pedestrians that are either in front of or behind said motorists. Furthermore, a government overriding capability would be especially desirable to convey messages regarding traffic, amber alerts, and other warnings that a government would find useful to convey to the public at large.

The device disclosed below addresses these needs by providing a device that can display a message prompted by the motorist of the attached vehicle or overridden by a government message.

B. Discussion of the Prior Art

As will be discussed immediately below, no prior art discloses a messaging system for a vehicle, which is attached onto a top surface of said vehicle and of which features a front and rear display for presentation of messages thereon that provides messages to other motorists or pedestrians in front of or behind said vehicle; wherein a remote provides a means of inputting the desired message; wherein a government override feature enables a government originated message to be displayed and of which involves commandeering use of the device involving wireless signals that communicate with a receiver included with the display.

The Cao et al. Patent Application Publication (U.S. Pub. No. 2005/0083183) discloses a vehicle courteous message display that is designed to express a driver's response when the need arises. However, the message display does not include a government override feature.

The Au et al. Patent Application Publication (U.S. Pub. No. 2008/0236007) discloses a roof mounted electronic display panel for automobiles. Again, the display panel does not feature a government override option, which usurps control of the display at the discretion of the government.

The Steffan et al. Patent (U.S. Pat. No. 5,905,434) discloses a vehicle communications system that displays a programmable message on the back window. Again, the communications systems does not include a government override feature.

The Selleck Patent Application Publication (U.S. Pub. No. 2004/0097195) discloses a vehicle-to-vehicle visual messaging system. However, the messaging system is only directed to vehicle-to-vehicle visual messaging, and not displaying messaging to anyone in sight thereof regardless of whether another vehicle is involved.

The Strein et al. Patent (U.S. Pat. No. 6,880,276) discloses an illuminated electronic display that employs LED's to form characters in a message. Again, the display does not offer a government override function, which usurps control of the display as a need arises.

The George Patent (U.S. Pat. No. 5,500,638) discloses a method of communications between vehicle operators that employ common display LED's. Again, the method is directed to communication between vehicle operators, and is not capable of displaying a message to anyone within visual contact.

The Christie Patent (U.S. Pat. No. 7,020,992) discloses a vehicle message display system. However, the system is not for use in directing a message in both a forward and rearward direction.

The Elmer Patent (U.S. Pat. No. 5,711,100) discloses an advertising display for use above the roof of a vehicle.

The Bahmad Patent (U.S. Pat. No. 6,553,285) discloses a message conveying system for a motor vehicle that allows a person operating a vehicle to display one of a plurality of messages to other motorists. However, the message conveying system does not allow for both frontward and rearward messages to be displayed.

While the above-described devices fulfill their respective and particular objects and requirements, they do not describe a messaging system for a vehicle, which is attached onto a top surface of said vehicle and of which features a front and rear display for presentation of messages thereon that provides messages to other motorists or pedestrians in front of or behind said vehicle; wherein a remote provides a means of inputting the desired message; wherein a government override feature enables a government originated message to be displayed and of which involves commandeering use of the device involving wireless signals that communicate with a receiver included with the display. In this regard, the automobile-messaging system having government override departs from the conventional concepts and designs of the prior art.

### SUMMARY OF THE INVENTION

The automobile-messaging system having government override is a messaging system that sits atop a vehicle and of which delivers highly visible messages in both a forward and rearward direction. A front display and rearward display are contained with a triangularly-shaped housing that includes translucent sides that enable sunlight to enter in order to produce electricity with solar cells located on an interior base of the housing. A remote can communicate with either the front or rear display to enable the respective motorist to input a desired message. A government override feature enables the government to commandeer use of the display by emitting a wireless signal that overrides any use of the system, and will display the desired government message. The messaging system is secured atop the vehicle by adhesives, magnets, clips, or clamps. The messaging system is powered via cigarette lighter electric cord, rechargeable batteries, and/or a plurality of solar cells.

An object of the invention is to provide a messaging system that displays a message atop a vehicle either frontwards and/or rearwards, and of which is inputted by a remote operated by the motorist of the respective vehicle.

A further object of the invention is to provide a government override feature that enables the government to usurp usage of the messaging system in order to display a message for public viewing.

A further object of the invention is to provide a front display and a rear display that can act independently.

These together with additional objects, features and advantages of the automobile-messaging system having government override will be readily apparent to those of ordinary skill in the art upon reading the following detailed description of presently preferred, but nonetheless illustrative, embodiments of the automobile-messaging system having government override when taken in conjunction with the accompanying drawings.

In this respect, before explaining the current embodiments of the automobile-messaging system having government override in detail, it is to be understood that the automobile-messaging system having government override is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the automobile-messaging system having government override.

It is therefore important that the claims be regarded as including such equivalent construction insofar as they do not depart from the spirit and scope of the automobile-messaging system having government override. It is also to be understood that the phraseology and terminology employed herein are for purposes of description and should not be regarded as limiting.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a front, isometric view of the automobile-messaging system having government override in which the first side of the housing, remote, and power plug are depicted as well as a radio tower;

FIG. 2 illustrates a rear, isometric view of the automobile-messaging system having government override and displaying the second side of the housing;

FIG. 3 illustrates a view depicting the housing into which the receiver is included and computing means, and also the adjustable attachable roof clamp is included;

FIG. 4 illustrates a bottom view depicting a pair of magnet strips as well as adjustable attachable roof clamps that are either horizontally or vertically oriented;

FIG. 5 illustrates a view of the automobile-messaging system having government override installed on a vehicle via the adjustable attachable roof clamps, and in which the front display illustrates the word “MESSAGE”; and

FIG. 6 illustrates a cross-sectional view of the automobile-messaging system along line 6-6 in FIG. 3, and depicting the forward and rearward display located within the housing, the solar cells located on the interior base of the housing.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

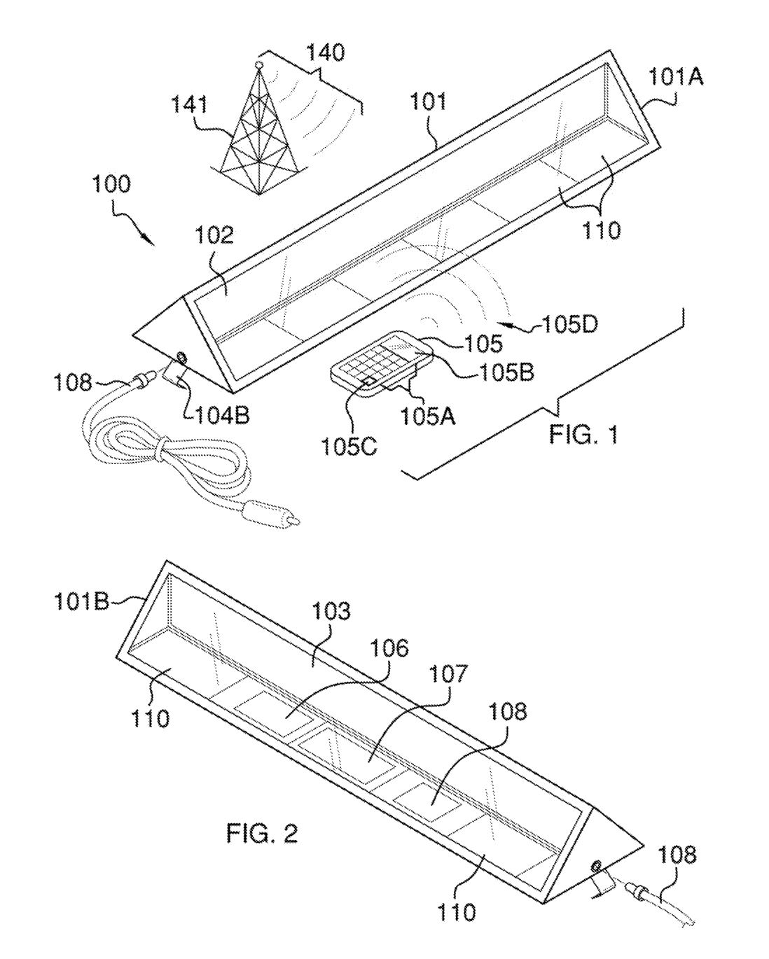

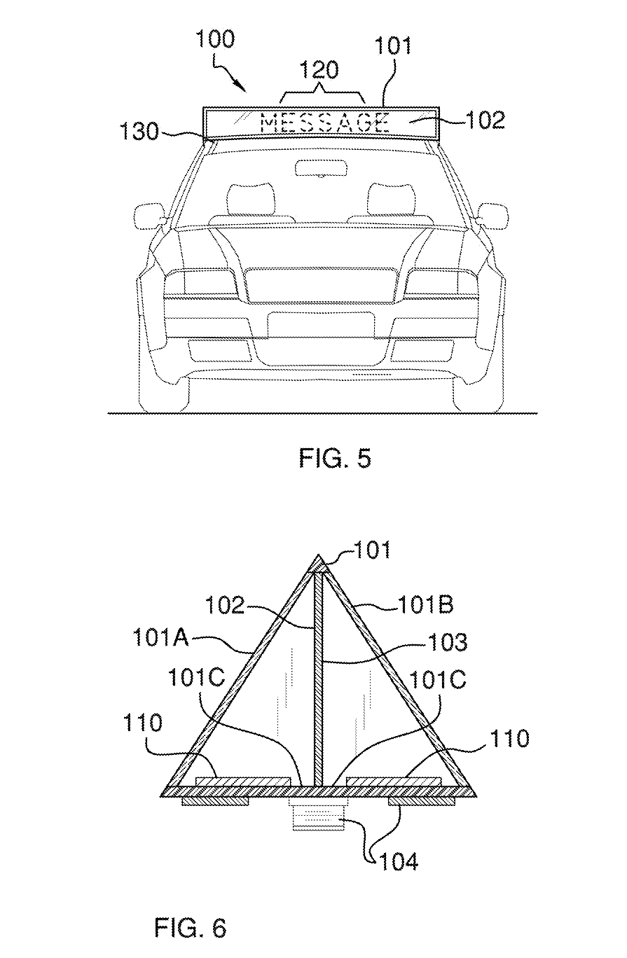

Detailed reference will now be made to the preferred embodiment of the present invention, examples of which are illustrated in FIGS. 1-6. An automobile-messaging system having government override 100 (hereinafter invention) includes a housing 101 having a triangular cross section further defined by a front surface 101A, a rear surface 101B, and a bottom surface 101C.

Both the front surface 101A and the rear surface 101B are made of translucent material such that light can enter through said surface and illuminate the bottom surface 101C. The housing 101 has an overall length of not less than 1 foot and not greater than 5 feet in length. The width of the front surface 101A and the rear surface 101B shall be no less than 3 inches and not more than 1 foot. The housing 101 is of hollow construction, which enables components of the invention 100 to be contained within.

Located within the housing 101 is a front display 102, and a rear display 103. The front display 102 and the rear display back up to one another such that the front display 102 is directed forwards, and the rear display is directed rearwards. More importantly, the front display 102 is located behind and is visible through the front surface 101A; the rear display 103 is located behind and is visible through the rear display 101B.

The front display 102 and the front surface 101A are forward facing with respect to a vehicle 130. The rear display 103 and the rear surface are rearward facing with respect to the vehicle 130.

A securing means 104 is provided on the bottom surface 101C, which is used to secure the housing 101 onto a top surface of the vehicle 130. The securing means 104 may be in the form of magnetic strips or adhesive strips 104A, which adorn the bottom surface 101C, and secure the invention atop said vehicle 130. The securing means 104 may also include adjustable roof clamps 104B that clamp onto said vehicle 130.

A remote 105 is provided and of which enables an end user to input a desired message 120 conveyed on either the front display 102 and/or the rear display 103.

A central processing unit 106 (hereinafter CPU) may also be referred to as computing means is responsible for receiving message inputs from the remote 105 or from a receiver 107.

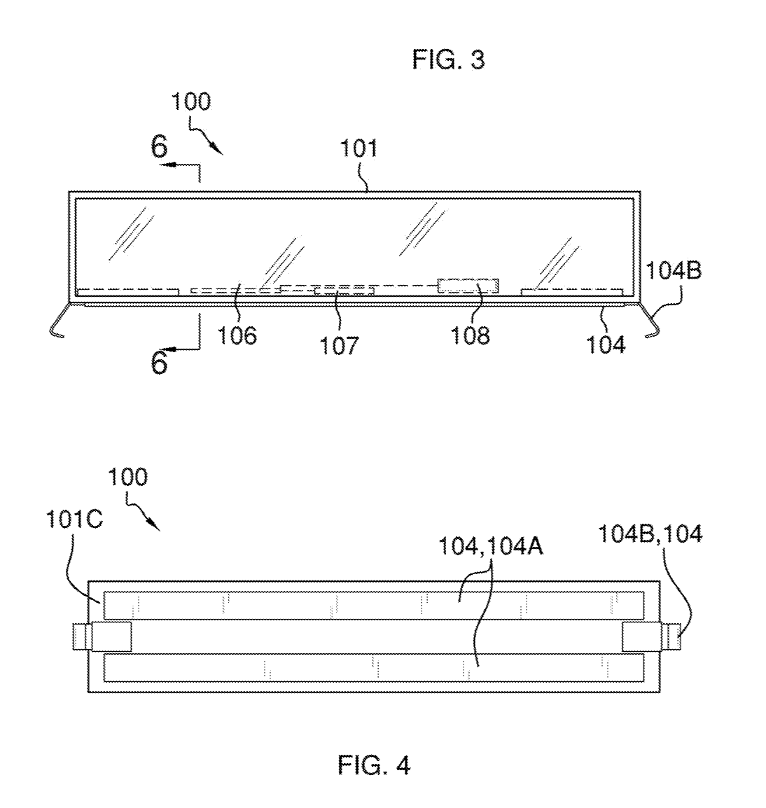

The CPU 106 is wired to both the front display 102 and the rear display 103, and controls the output of the respective displays. The CPU 106 is wired to a powering means 108, which comprises an electric cord that plugs into a cigarette lighter of a vehicle (see FIG. 1-2) and/or at least one rechargeable battery (see FIG. 3).

The receiver 107 is included, and can receive a government signal 140 emitted by a government transmitter 141, which enables local, regional, or national government agencies to emit said signal. The signal when received by the receiver 107 can be directed to use of motorways, traffic, weather advisory, AMBER alerts, etc. The signal received by the receiver 107 will override the function of the invention 100 by the remote 105, and convey a message on the front display 102 and/or rear display 103 for a proscribed period of time.

Additionally, the receiver 107 can receive a signal 105D from the remote 105, which then enables operation of the front display 102 and the rear display 103 to be completed by the end user.

More particularly, the remote 105 shall include a plurality of buttons 105A that enable an end user to input letters, symbols, or numbers. The remote 105 may also includes a display 105B that enables an end user to see what message is being typed in. The remote 105 also includes an enter button 105C that transmits the desired message via the signal to the receiver 107, and enables the end user to decide when the message is displayed. The remote 105 shall also be capable of accepting, remembering and transmitting pre-programmed messages entered in by an end user.

It shall be noted that whether the remote 105 or the government signal 140 is transmitted to the receiver 107, an encoded signal shall dictate the duration with which the message is being displayed. The CPU 106 interrupts the signal received by the receiver 107 and inputs the message into the front display 102 and the rear display 103.

It shall be noted that a message 120 displayed by the invention 100 may involve alphanumeric representations, which requires a target audience to be literate. The front display 102 and the rear display 103 may involve an LCD screen or an array of light emitting diodes.

The bottom surface 101C is split into two halves via the front display 102 and the rear display 103. Located on the bottom surface 101C is a plurality of solar cells 110. The solar cells 110 are located within the housing 101, and produce electricity when light reaches the solar cells 110. Since the front surface 101A and the rear surface 101B are transparent, the solar cells 110 can produce electricity upon receipt of light passing through said surfaces. It shall be noted that the inclusion of the hollow housing 101 in conjunction with the design and location of the solar cells 110 is an important feature of the invention 100. More particularly, the location of the solar cells 110 inside of the housing 101, which is atop the vehicle 130, and is ideally suited for receiving light at said location.

It shall be noted that the solar cells 110 are wired to the powering means 108, which ideally involves the use of at least one rechargeable battery as depicted in FIG. 3. The solar cells 110 are responsible for providing electricity to the invention 100 in order to operate the CPU 106 and/or recharge the powering means 108. It shall be further noted that the solar cells 110 may be used to power the invention 100, and not solely to recharge the rechargeable battery.

With respect to the above description, it is to be realized that the optimum dimensional relationship for the various components of the invention 100, to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the invention 100.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A automobile-messaging system having government override, further comprising:
a front display and a rear display are wired to a receiver;
wherein the front display can display a message in forward direction with respect to a vehicle:
wherein the rear display can display the message or a different message in a rearward direction with respect to the vehicle;
wherein an end user within said vehicle can operate a remote, which input messages onto either or both the front and rear display via a signal received by said receiver;
wherein a government may override said messaging system upon sending a signal via a transmitter to said receiver, which usurps operation of the messaging system by said end user.

2. The automobile-messaging system having government override as described in claim 1 wherein the front display and the rear display are located within a housing that includes a front surface and a rear surface; wherein the front surface and the rear surface are transparent such that the front display and the rear display are visible from outside of the housing.

3. The automobile-messaging system having government override as described in claim 2 wherein said housing has a triangular cross-section comprised of the front surface, the rear surface, and a base surface.

4. The automobile-messaging system having government override as described in claim 3 wherein the bottom surface of the housing includes securing means that secure the messaging system to a top surface of said vehicle.

5. The automobile-messaging system having government override as described in claim 4 wherein the securing means comprises at least one magnet or adhesive strip or a plurality of adjustable roof clamps.

6. The automobile-messaging system having government override as described in claim 2 wherein a powering means is provided and supplies electricity to the receiver, the front display, and the rear display.

7. The automobile-messaging system having government override as described in claim 6 wherein the powering means comprises at least one rechargeable battery or an electric cord that plugs into a cigarette lighter of said vehicle.

8. The automobile-messaging system having government override as described in claim 7 wherein a plurality of solar cells are located inside of the housing and upon the bottom surface such that light enters through the transparent front surface and rear surface to produce electricity from the solar cells; wherein said electricity is used to power the automobile-messaging system or to recharge said rechargeable battery.

9. The automobile-messaging system having government override as described in claim 1 wherein the government signal or the signal of the remote encode the duration with which to display said message on the front display and/or rear display.

10. The automobile-messaging system having government override as described in claim 1 wherein the remote includes a plurality of buttons that enable the end user to input letters, symbols, or numbers; wherein the remote includes a display enabling the end user to see what message is being typed in; wherein the remote includes an enter button that transmits the desired message via the signal to the receiver, and enables the end user to decide when the message is displayed.

11. The automobile-messaging system having government override as described in claim 1 wherein the front display and the rear display are comprised of an LCD screen or an array of light emitting diodes.

12. A automobile-messaging system having government override, further comprising:
a front display and a rear display are wired to a receiver;
wherein a powering means is provided and supplies electricity to the receiver, the front display, and the rear display;
wherein the front display can display a message in forward direction with respect to a vehicle;
wherein the rear display can display the message or a different message in a rearward direction with respect to the vehicle;
wherein an end user within said vehicle can operate a remote, which input messages onto either or both the front and rear display via a signal received by said receiver;
wherein a government may override said messaging system upon sending a signal via a transmitter to said receiver, which usurps operation of the messaging system by said end user.

13. The automobile-messaging system having government override as described in claim 12 wherein the front display and the rear display are located within a housing that includes a front surface and a rear surface; wherein the front surface and the rear surface are transparent such that the front display and the rear display are visible from outside of the housing.

14. The automobile-messaging system having government override as described in claim 12 wherein the bottom surface of the housing includes securing means that secure the messaging system to a top surface of said vehicle; wherein the securing means comprises at least one magnet or adhesive strip or a plurality of adjustable roof clamps.

15. The automobile-messaging system having government override as described in claim 12 wherein the powering means comprises at least one rechargeable battery or an electric cord that plugs into a cigarette lighter of said vehicle.

16. The automobile-messaging system having government override as described in claim 15 wherein a plurality of solar cells are located inside of the housing and upon the bottom surface such that light enters through the transparent front surface and rear surface to produce electricity from the solar cells; wherein said electricity is used to power the automobile-messaging system or to recharge said rechargeable battery

17. The automobile-messaging system having government override as described in claim 12 wherein the government signal or the signal of the remote encode the duration with which to display said message on the front display and/or rear display.

18. The automobile-messaging system having government override as described in claim 12 wherein the remote includes a plurality of buttons that enable the end user to input letters, symbols, or numbers; wherein the remote includes a display enabling the end user to see what message is being typed in; wherein the remote includes an enter button that transmits the desired message via the signal to the receiver, and enables the end user to decide when the message is displayed.

19. The automobile-messaging system having government override as described in claim 12 wherein the front display and the rear display consist of an LCD screen or an array of light emitting diodes.
